(19) United States
(12) Patent Application Publication
(10) Pub. No.: US 2014/0043703 A1
(43) Pub. Date: Feb. 13, 2014

(54) OPTICAL LENS MODULE

(71) Applicant: Wu-Li Wang, Tainan City (TW)

(72) Inventor: Wu-Li Wang, Tainan City (TW)

(21) Appl. No.: 13/584,003

(22) Filed: Aug. 13, 2012

(51) Int. Cl. G02B 7/02

(52) U.S. Cl. 359/827

(57) ABSTRACT

An optical lens module includes a barrel, a lens frame, and a driving device. The lens frame is mounted in the barrel for reciprocation and has at least a lens. The driving device has a fixed coil and a movable coil. The fixed coil is provided on the barrel, and the movable coil provided on the lens frame. Therefore, the lens frame is moved by the fixed coil while power is supplied to the fixed coil and the movable coil. Therefore, high temperature will not make the coils losing magnetism, and the concept of the present invention may move multiple lens frames.

### BACKGROUND OF THE INVENTION

1. Field of the Invention

The present invention relates generally to an optical device, and more particularly to an optical lens module.

2. Description of the Related Art

As the improvement of technology image capture devices, such as digital camera, cell phone with camera, video game console and PDA, are very popular in ordinary life to record things.

FIG. 1 shows a conventional optical lens module, including a barrel 60 and a lens group 62 mounted in the barrel 60 for reciprocation. The barrel 60 is provided with a coil 70, and a magnet 72 is provided on the lens group 62 so that the lens group 70 is moved by the magnet set 72 for focusing.

In the conventional optical lens module, it may have a plurality of magnet sets, and each magnet is provided on a lens frame (such as focusing frame and zooming frame). At this time, the magnets will affect each other so that the optical lens module will have trouble in focusing or zooming. Therefore, the lens group only moves for focusing in the conventional optical lens module, and zooming is achieved by digital process. It is known that the digital zoom is a method of decreasing (narrowing) the apparent angle of view of a digital photographic or video image so that the image's quality is poor because of the limited pixels of the optical lens module.

The electronic elements in the conventional image capture devices are connected by reflow. The reflow process is performed in a high temperature environment, usually is hundreds degrees, so that the magnets may lose its magnetism in high temperature. It may increase the ratio of defective in manufacture of the conventional optical lens module, and furthermore, it affects focusing.

### SUMMARY OF THE INVENTION

The primary objective of the present invention is to provide an optical lens module, which is not affected by high temperature and may drive multiple lens groups to move.

According to the objective of the present invention, an optical lens module includes a barrel, at least a lens frame, and a driving device. The lens frame is mounted in the barrel for reciprocation and has at least a lens. The driving device has a fixed coil and a movable coil. The fixed coil is provided on the barrel, and the movable coil provided on the lens frame. Therefore, the lens frame is moved by the fixed coil while power is supplied to the fixed coil and the movable coil.

In an embodiment, the driving device further includes a telescoping wire connected to the movable coil.

In an embodiment, the driving device further includes a flexible member; and the flexible member urges the lens frame to return the lens frame when the lens frame is moved.

In an embodiment, the flexible member is conductive; and the power is supplied to the movable coil through the flexible.

In an embodiment, the movable coil is repelled by the fixed coil when power is supplied to the fixed coil and the movable coil.

In an embodiment, the optical lens module has two or more lens frames, and each lens frame is provided with a movable coil. Therefore, the lens frames are respectively moved by the fixed coil while power is supplied to the coils.

Therefore, high temperature will not make the coils losing magnetism, and the concept of the present invention may move multiple lens frames.

### BRIEF DESCRIPTION OF THE DRAWINGS

FIG. 1 is a sectional view of the conventional optical lens module;

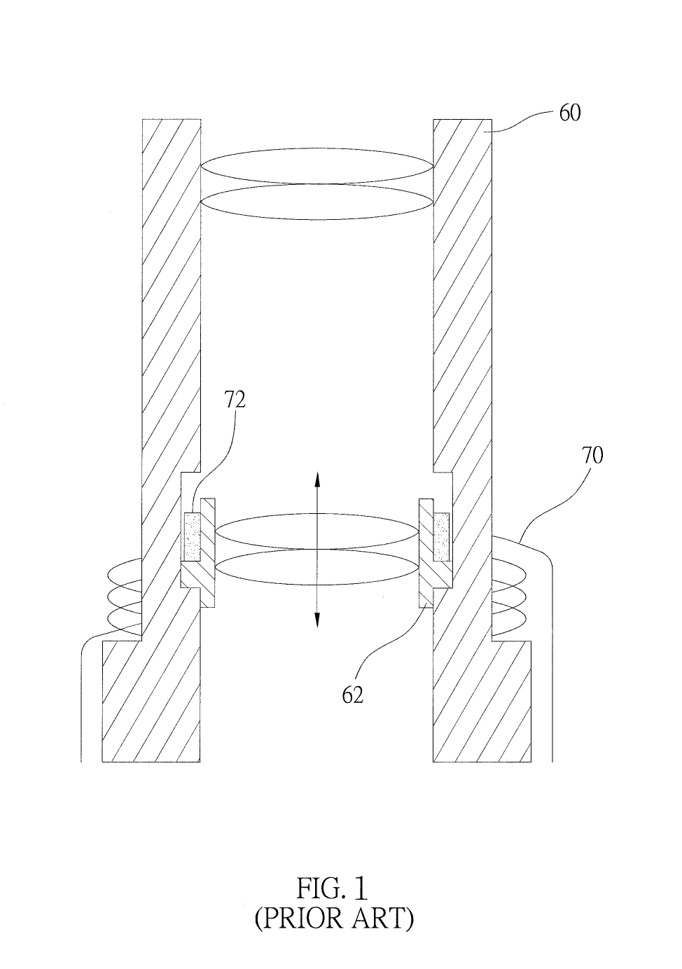

FIG. 2 is a sectional view of a first preferred embodiment of the present invention;

FIG. 3 is a sectional view of a second preferred embodiment of the present invention; and

FIG. 4 is a sectional view, showing the flexible member and the coil.

### DETAILED DESCRIPTION OF THE INVENTION

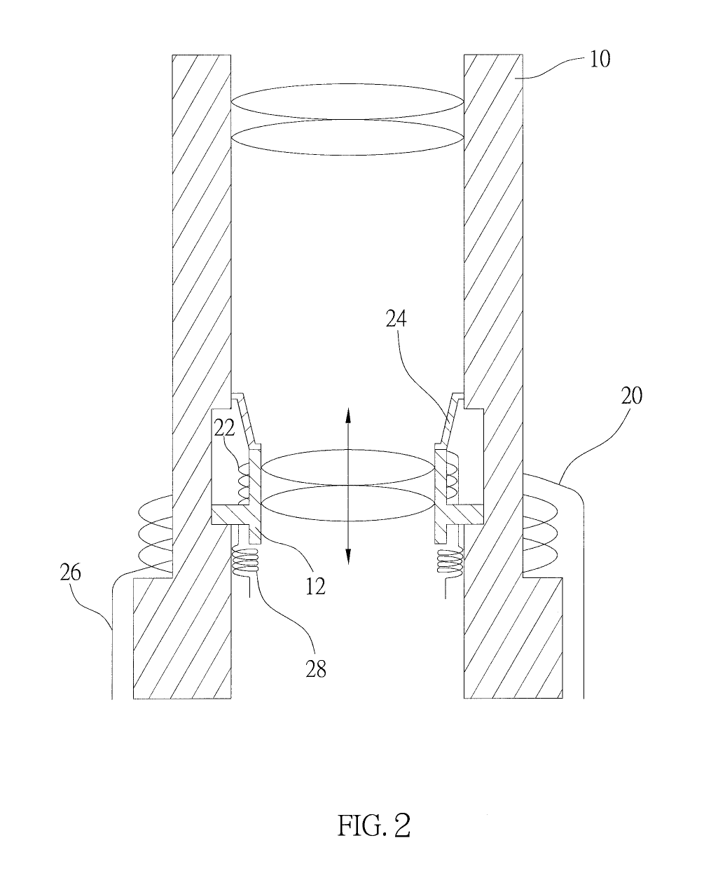

As shown in FIG. 2, an optical lens module of the first preferred embodiment of the present invention includes a barrel 10, a lens frame 15, and a driving device.

The barrel 10 has a plurality of lenses.

The lens frame 12 has a plurality of lenses. The lens frame 12 is mounted in the barrel 10 for reciprocation in a predetermined distance.

The driving device includes a fixed coil 20, a movable coil 22, a flexible member 24, and two wires 26 and 28. The fixed coil 20 is wound around the barrel 10, and the movable coil 22 is wound around the lens frame 12. The movable coil 22 moves with the lens frame 12. The flexible member 24 urges the lens frame 12 to restrict the lens frame 12 in the barrel 10. The wire 26 is connected to the fixed coil 20. The wire 28 is a coiled wire so that the wire 28 is telescopic. The wire 28 is connected to the movable coil 22.

The movable coil 22 is repelled by the fixed coil 20 while power is supplied to the driving device for focusing. At this time, the lens frame 15 is moved toward the lens of the barrel 10 and compresses the flexible member 24. The coiled wire 28 elongates or shortens as the movement of the lens frame 15. The coils 20 and 22 are just pieces of metal without current so that it won't have to concern about the magnetism lost problem in high temperature of reflow.

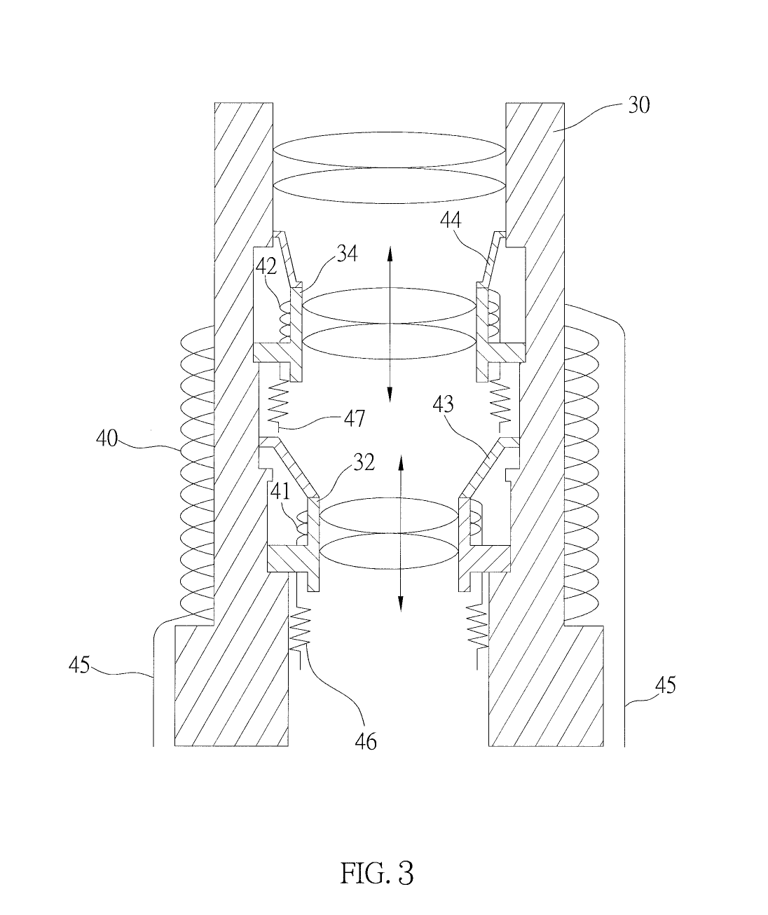

As shown in FIG. 3, an optical lens module of the second preferred embodiment of the present invention includes a barrel 30, a focusing lens frame 32, a zooming lens frame 34, and a driving device.

The barrel 30, the focusing lens frame 32, and the zooming lens frame 34 respectively have a plurality of lenses. The focusing lens frame 32 and the zooming lens frame 34 are mounted in the barrel 30 for reciprocation respectively. The zooming lens frame 34 is between the lenses of the barrel 30 and the focusing lens frame 32.

The driving device includes a fixed coil 40, a first movable coil 41, a second movable coil 42, a first flexible member 43, a second flexible member 44 and three wires 45-47. The fixed coil 40 is wound around the barrel 30, the first movable coil 41 is wound around the focusing lens frame 32, and the second movable coil 42 is wound around the zooming lens frame 34. The first flexible member 43 urges the focusing lens frame 32, and the second flexible member 44 urges the zooming lens frame 34. The wires 45-47 are respectively connected to the fixed coil 40, the first movable coil 41, and the second movable coil 42. The wires 46 and 47 are saw-tooth-like wires for telescoping. The focusing lens frame 32 and the zooming lens frame 34 will be moved while power is supplied to the wires 45-47 for focusing and zooming. The magnetic forces of the first movable coil 41 and the second movable coil 42 will be interacted, and it may precisely control the moving distances of the focusing lens frame 32 and the zooming lens frame 34 by changing the power supplied to the coils 41 and 42 to achieve a precise focusing and zooming.

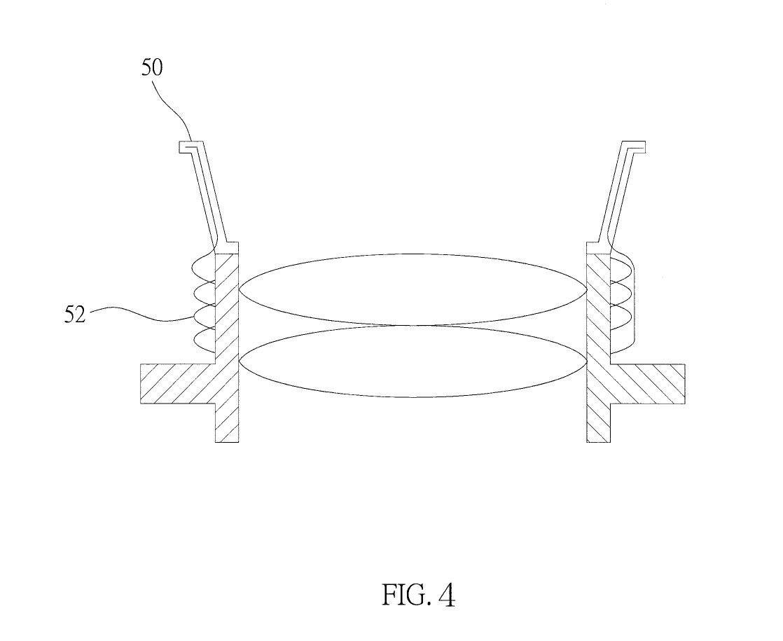

FIG. 4 shows a conductive flexible member 50. The flexible member 50 contacts a movable coil 52 so that power is supplied to the movable coil 52 through the flexible member 50. It may reduce the size of the optical lens module.

It is easy to understand that the present invention may have three or more lens frames, and each lens frame has a coil to drive the lens frames by magnetic force. The description above is a few preferred embodiments of the present invention and the equivalence of the present invention is still in the scope of claim construction of the present invention.

What is claimed is:

1. An optical lens module, comprising:
a barrel;
at least a lens frame mounted in the barrel for reciprocation, wherein the lens frame has at least a lens; and
a driving device having a fixed coil provided on the barrel and a movable coil provided on the lens frame;
wherein the lens frame is moved by the fixed coil while power is supplied to the fixed coil and the movable coil.

2. The optical lens module as defined in claim 1, wherein the driving device further includes a telescoping wire connected to the movable coil.

3. The optical lens module as defined in claim 1, wherein the driving device further includes a flexible member; and the flexible member urges the lens frame to return the lens frame when the lens frame is moved.

4. The optical lens module as defined in claim 3, wherein the flexible member is conductive; and the flexible member contacts the movable coil whereby the power is supplied to the movable coil through the flexible.

5. The optical lens module as defined in claim 1, wherein the movable coil is repelled by the fixed coil when the power is supplied to the fixed coil and the movable coil.

6. An optical lens module, comprising:
a barrel;
a focusing lens frame mounted in the barrel for reciprocation, wherein the focusing lens frame has at least a lens;
a zooming lens frame mounted in the barrel for reciprocation, wherein the zooming lens frame has at least a lens; and
a driving device having a fixed coil provided on the barrel, a first movable coil provided on the focusing lens frame, and a second movable coil provided on the zooming lens frame;
wherein the focusing lens frame and the zooming lens frame are respectively moved by the fixed coil while power is supplied to the fixed coil, the first movable coil, and the second movable coil.
